(19) United States
(12) Patent Application Publication
(10) Pub. No.: US 2023/0133609 A1
(43) Pub. Date: May 4, 2023

(54) Embossing Device for Embossing a Marking on a Motor Vehicle Component, and Tool for Processing a Motor Vehicle Component

(71) Applicant: Bayerische Motoren Werke Aktiengesellschaft, Muenchen (DE)

(72) Inventors: Bernhard GLUECK, Fuerstenfeldbruck (DE); Robert KIRSCHNER, Olching (DE); Peter SOELL, Bodenkirchen (DE)

(21) Appl. No.: 17/917,813

(22) PCT Filed: May 31, 2021
(86) PCT No.: PCT/EP2021/064487

§ 371 Date: Oct. 7, 2022

(30) Foreign Application Priority Data
Jun. 22, 2020 (DE) 10 2020 116 373.8

(51) Int. Cl. B44B 5/00

(52) U.S. Cl. CPC B44B 5/0076; B44B 5/0009

(57) ABSTRACT

An embossing device for embossing a marking on a motor vehicle component includes a fastening device via which the embossing device can be fastened to a tool, by which tool the motor vehicle component can be processed. An embossing unit is held on the fastening device and has the marking in negative form, by which embossing unit the marking can be embossed into the motor vehicle component by the tool. A spring device is provided, by which the fastening device can be spring-mounted on the tool.

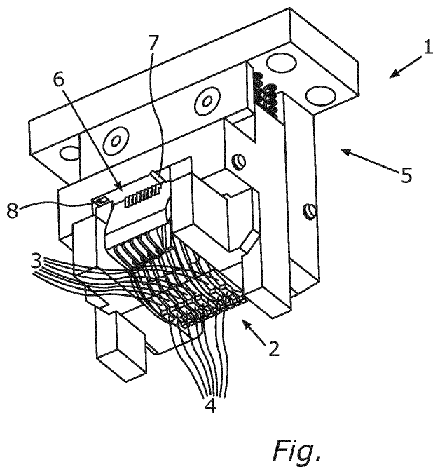

### BACKGROUND AND SUMMARY

The invention relates to an embossing device for embossing a marking on a motor vehicle component and to a tool for processing a motor vehicle component.

An embossing stamp for applying markings to non-planar surface regions of components to be labelled is already known from DE 198 35 993 A1, wherein the embossing stamp comprises an stamping head attached to a stamp holder and with letters held thereon by means of letter holders. The individual letters are supported on the side opposite their embossing surface so that they can move independently of one another on an elastic pressure-equalizing element. The elastic pressure-equalizing element is arranged between the counterpressure surface, formed on the stamp holder, and the letter holders. The embossing stamp thus effects elastic mounting of the individual letters, which can move relative to one another in the direction of the pressure at the surface situated opposite the embossing surface and at which the embossing pressure is transmitted to the letters.

The object of the present invention is to provide an embossing device for embossing a marking on a motor vehicle component, and a tool for processing a motor vehicle component, which make it possible for the marking to be applied particularly uniformly to a motor vehicle component in the case of the embossing device striking the motor vehicle component at an angle.

This object is achieved according to the invention by an embossing device for embossing a marking on a motor vehicle component and by a tool for processing a motor vehicle component having the features of the independent patent claims. Advantageous embodiments of the invention are the subject of the dependent patent claims and the description.

The invention relates to an embossing device for embossing a marking on a motor vehicle component, with a fastening device via which the embossing device can be fastened to a tool. The motor vehicle component can be processed by means of the tool. The embossing device furthermore comprises an embossing unit, held on the fastening device, having the marking in negative, and by means of which the marking can be embossed into the motor vehicle component by means of the tool when the motor vehicle component is processed. In other words, the embossing unit can be integrated into the tool, as a result of which, when the motor vehicle component is processed by means of the tool, the marking can be applied to or placed on the motor vehicle component simultaneously via the embossing unit.

In order to be able to uniformly apply the marking to the motor vehicle component with a fixed predetermined spacing between respective marking elements of the marking, according to the invention a spring device of the embossing device is provided by means of which the fastening device can be spring-mounted on the tool. Respective embossing elements, providing marking elements, of the embossing unit are thus fixed in their respective orientation relative to one another.

The embossing unit is spring-mounted as a whole on the tool via the fastening device. The embossing unit can thus be cushioned as a whole relative to the spring device in the case of the embossing elements of the embossing unit striking at an angle a surface of the motor vehicle component to be provided with the marking. The angled striking of the embossing elements of the embossing unit against the surface of the motor vehicle component can be compensated via the elastic cushioning of the embossing unit. Maintenance of a defined spacing between the respective marking elements, predetermined by the embossing elements, of the marking applied to the motor vehicle component, relative to one another can be ensured by fixing the embossing elements of the embossing unit in their orientation relative to one another.

In a further embodiment of the invention, it has been shown to be advantageous if the spring device has a pressure-limiting device by means of which a pressure applied to the motor vehicle component by the embossing unit when the marking is embossed can be limited. This means that the spring device is designed so that it can yield, wherein the pressure-limiting device is configured to yield as soon as a pressure acting on the embossing unit, in particular from the motor vehicle component, exceeds a predetermined maximum pressure. In particular, the pressure-limiting device can be plastically deformable as soon as the predetermined maximum pressure has been exceeded, as a result of which a further increase in the pressure acting on the embossing unit or on the motor vehicle component from the embossing unit can be limited to the predetermined maximum pressure. As a result, damage to the motor vehicle component and damage to the embossing unit can be essentially prevented by an excessively high pressure when the marking is applied to the motor vehicle component by means of the embossing unit.

In a further embodiment of the invention, it has been shown to be advantageous if the spring device comprises at least one cup spring and/or at least one gas pressure spring and/or at least one rubber shim and/or at least one hydraulic device. The embossing unit can be spring-mounted particularly advantageously on or in the tool by means of the at least one cup spring and/or the at least one gas pressure spring and/or the at least one rubber shim and/or the at least one hydraulic device. Cup springs advantageously have a particularly high degree of elasticity and toughness with particularly high strength. Providing the at least one gas pressure spring in the spring device has the advantage that the gas pressure spring has a force which is virtually independent of a spring travel, as well as a particularly small space requirement. The pressure-limiting device can, for example, be integrated into the gas pressure spring, as a result of which the spring device with the pressure-limiting device can be supplied in a particularly compact and space-saving fashion. Moreover, a damping mechanism can be integrated into the gas pressure spring. The rubber shim is an intermediate layer made from an elastic material, in particular rubber. This intermediate layer has in particular a particularly simple structure and can therefore be particularly cost-effective. The hydraulic device can, for example, have a cylinder filled with a hydraulic liquid, in particular with oil, and a piston rod guided therein, wherein a spring effect of the hydraulic device can be provided by guiding the piston rod in the cylinder. Resistance of the hydraulic device advantageously increases gradually and hence with a flow speed of the hydraulic liquid arranged in the hydraulic device. Depending on the requirement for the respective spring-mounting, the spring device can thus comprise the at least one cup spring and/or the at least one gas pressure spring and/or the at least one rubber shim and/or the at least one hydraulic device.

In a further embodiment of the invention, it has been shown to be advantageous if the spring device is configured to cushion the fastening device relative to the tool via a non-Newtonian fluid. In particular, the spring device is configured to cushion the fastening device relative to the tool via a non-Newtonian liquid. A viscosity of the non-Newtonian fluid is not constant when there is a change in the shearing forces acting on the fluid. By respectively selecting the non-Newtonian fluid in the fastening device, it is possible to predetermine specifically that the spring device is cushioned more or less strongly relative to the tool in the event of an impact load than when a force is applied slowly to the embossing unit. The respective damping properties of the spring device can be provided via the non-Newtonian fluid particularly advantageously outside a proportional range for the exertion of force to the embossing unit and the damping effect of the fastening device.

In a further embodiment of the invention, it has been shown to be advantageous if the embossing device can be fastened as a tool to a forming tool via the fastening device. The motor vehicle component can be cold formed or hot formed by means of the forming tool, wherein the marking can be introduced into the motor vehicle component by means of the embossing device during a forming procedure of the motor vehicle component. The motor vehicle component can thus simultaneously be formed by means of the forming tool and provided with the marking by means of the embossing device. The marking embossed on the motor vehicle component by means of the embossing device during the forming can here characterize the forming procedure. Alternatively or additionally, the marking embossed on the motor vehicle component by means of the embossing device can clearly identify the motor vehicle component, for example because the marking is a serial number for the motor vehicle component. The motor vehicle component is in particular a plate, wherein the plate can be formed by means of the forming tool to produce a motor vehicle component. By virtue of the possibility of fastening the embossing device to the forming tool and in particular integrating it into the forming tool, the motor vehicle component can both be formed and provided with the marking in particularly few processing steps and hence in a particularly short cycle time.

In a further embodiment of the invention, it has been shown to be advantageous if the embossing unit has at least two stamping wheels by means of which the marking can be set and can be embossed into the motor vehicle component and which can be cushioned together relative to the tool via the spring device. Each of the stamping wheels can have at least one embossing element, wherein each embossing element is configured to emboss a marking element of the marking into the motor vehicle component. The stamping wheels are oriented concentrically relative to one another in particular with their respective center axes about which the stamping wheels can revolve such that the center axes of the stamping wheels coincide. The stamping wheels thus have at all times the same mutual spacing from the fastening device. The stamping wheels of the embossing unit can be cushioned relative to the tool together by means of the spring device. The stamping wheels can each revolve independently of one another about their center axis, as a result of which respective embossing elements arranged on the periphery of the stamping wheels can be oriented relative to one another in order to set the marking to be embossed into the motor vehicle component. The at least two stamping wheels of the embossing unit make it possible, in the case of motor vehicle components embossed one after the other by means of the embossing device, for different markings to be embossed into the motor vehicle components. As a result, it is possible to provide the motor vehicle components embossed one after the other by means of the embossing device with in each case individual markings, in particular serial numbers. In order thus to ensure that the markings embossed into the multiple motor vehicle components can be read electronically particularly well and with little likelihood of error, the embossing unit is cushioned as a whole relative to the tool such that a respective spacing between respective embossing elements, supplying a negative of the marking, of the stamping wheels relative to one another is constant and thus is the same independently of a spring state of the spring device. Cushioning of the individual stamping wheels relative to one another does not take place in the embossing device provided. As a result, a uniform spacing between respective marking elements of the marking on the motor vehicle component can be ensured.

The invention furthermore relates to a tool for processing a motor vehicle component with an embossing device as has already been described in connection with the embossing device according to the invention. The embossing device can be fastened to the tool via a fastening device of the embossing device, in particular can be integrated into the tool. A marking can be embossed into the motor vehicle component by means of the embossing device when the motor vehicle component is processed. Particularly short cycle times can consequently be achieved when the motor vehicle component is processed and marked.

Advantages and advantageous developments of the embossing device according to the invention are to considered advantages and advantageous developments of the tool according to the invention, and vice versa. For this reason, the further advantages and advantageous developments of the tool according to the invention are not described again here.

Further features of the invention are apparent from the claims, the drawing, and the description of the drawing. The features and combinations of features mentioned above in the description, as well as the features and combinations of features mentioned below in the description of the drawing and/or shown individually in the single FIG., can be used not only in the respective stated combination but also in other combinations or individually.

The invention will now be explained in detail with the aid of a preferred exemplary embodiment and with reference to the drawing.

### BRIEF DESCRIPTION OF THE DRAWING

The single FIG. is a schematic perspective view of an embossing device for embossing a marking on a motor vehicle component with an embossing unit which can be fastened via a fastening device to a tool by which the motor vehicle component can be processed, wherein the embossing device comprises a spring device by which the fastening device can be cushioned relative to the tool and by which the embossing unit can be cushioned relative to the tool via the fastening device.

### DETAILED DESCRIPTION OF THE DRAWING

An embossing device 1 is shown in the single FIG. The embossing device 1 can be fastened to a tool by means of which a motor vehicle component can be processed. The tool is in particular a forming tool by which the motor vehicle component can be formed. A marking can be embossed into a surface of the motor vehicle component by way of the embossing device 1 when the motor vehicle component is formed by the forming tool. The marking is in particular a serial number of the motor vehicle component. The embossing device 1 can be brought into contact with a surface of the motor vehicle component, wherein the embossing device 1 can be pressed onto the surface of the motor vehicle component with pressure, as a result of which the marking can be embossed into the surface of the motor vehicle component. The embossing device 1 can also be referred to as a so-called counting stamp by way of which a code, in particular a seven-digit number, can be embossed into the motor vehicle component as a marking.

The embossing device 1 comprises an embossing unit 2 by which the marking can be embossed into the surface of the motor vehicle component by contact with the surface of the motor vehicle component. The embossing unit 2, which can be seen in the single FIG., comprises in the present case multiple stamping wheels 3 which have a common axis of rotation about which the stamping wheels 3 can rotate relative to one another. Each stamping wheel 3 has at least one embossing element 4. In particular, each stamping wheel 3 can have multiple embossing elements 4 which are distributed over the periphery of the respective stamping wheel 3. By revolving the respective stamping wheel 3 about the axis of rotation, the respective embossing elements 4 of the stamping wheels 3 can be oriented relative to one another and relative to the surface of the motor vehicle component and the marking to be embossed thus set. In particular, it is possible to select at each stamping wheel 3 an embossing element 4 which, by revolving the respective stamping wheel 3 about the axis of rotation, is arranged facing the surface of the motor vehicle component such that the selected embossing elements 4 together represent in negative the marking to be embossed into the surface of the motor vehicle component.

The embossing unit 2 can be fastened to the tool via a fastening device 5 which in the present case has a multi-part design. The embossing device 1 can be integrated into the tool by fastening the embossing device 1 to the tool via the fastening device 5.

Because of the varying thickness that exists in practice of the sheet metal of the motor vehicle component to be provided with the marking, the marking can sometimes be embossed more deeply into the motor vehicle component and sometimes less deeply in the case of different motor vehicle components embossed one after the other by means of an embossing device from the prior art. The situation can consequently arise where the visibility and/or readability of the embossing and hence the marking is not ensured for each of the embossed motor vehicle components. A particularly high degree of wear of this embossing device and/or damage to the motor vehicle component can be caused by a tilted position or an uneven surface and hence the striking of this embossing device against the motor vehicle component at an angle other than 90°. The particularly high degree of wear of this embossing device can negatively influence a quality of respective markings embossed in motor vehicle components and cause high costs when this embossing device needs to be repaired. A different amount of wear can occur at individual stamping wheels of the embossing unit because of different pressure or a tilted position or a different embossing depth of an embossing unit of this embossing device on the surface of the motor vehicle component. In the case of press tool embossing units placed rigidly on the tool, a different embossing depth and/or different embossing pressures can occur when the respective marking is embossed into the motor vehicle component, as a result of which particularly high maintenance costs and/or adaptation costs and/or servicing costs can result.

In order to overcome these disadvantages, the present embossing device 1 comprises a spring device 6. The embossing unit 2 can be cushioned relative to the tool by way of the spring device 6. In the present case, the embossing unit 2 can be cushioned relative to the fastening device 5 by use of the spring device 6. The fastening device 5 can be fixed in position on the tool. The spring device 6 thus enables the embossing unit 2 to be spring-mounted on the tool via the fastening device 5.

In particular, the spring device 6 can comprise multiple spring elements 7 via which the embossing unit 2 is cushioned relative to the fastening device 5. In the present case, at least one of the spring elements 7 is designed as a helical spring or as a cup spring which is supported at one end against the embossing unit 2 and at the other end against the fastening device 5. As an alternative to the embodiment of the spring elements 7 as helical springs or as cup springs, at least one of the spring elements 7 can be designed as a gas pressure spring or a hydraulic device. As an alternative or in addition to the provision of the multiple spring elements 7 of the spring device 6, the spring device 6 can comprise at least one rubber shim or cushioning using a non-Newtonian fluid.

In order to limit a pressure acting on the surface of the motor vehicle component from the embossing unit 2, the spring device 6 can comprise a pressure-limiting device 8 indicated schematically by a small box in the FIG. A pressure acting on the motor vehicle component from the embossing unit 2 when the marking is embossed can be limited by means of the pressure-limiting device 8 such that a predetermined maximum pressure is prevented from being exceeded by the pressure-limiting device 8. As a result, damage to the embossing unit 2 and the motor vehicle component can be prevented.

As a whole, the invention demonstrates how self-compensating maintenance can be provided at the counting stamp.

### LIST OF REFERENCE NUMERALS

1 embossing device
2 embossing unit
3 stamping wheel
4 embossing element
5 fastening device
6 spring device
7 spring element
8 pressure-limiting device

1.-7. (canceled)

8. An embossing device for embossing a marking on a motor vehicle component, comprising:
a fastening device via which the embossing device is fastenable to a tool by which the motor vehicle component is processed;
an embossing unit held on the fastening device, wherein the embossing unit has the marking in negative, and by which embossing unit the marking is embossable into the motor vehicle component by use of the tool when the motor vehicle component is processed; and
a spring device by which the fastening device is spring-mounted on the tool.

9. The embossing device according to claim 8, wherein
the spring device comprises a pressure-limiting device by which a pressure applied to the motor vehicle component by the embossing unit when the marking is embossed is limited.

10. The embossing device according to claim 8, wherein
the spring device comprises at least one cup spring, at least one gas pressure spring, at least one rubber shim, and/or at least one hydraulic device.

11. The embossing device according to claim 8, wherein
the spring device is configured to cushion the fastening device relative to the tool via a non-Newtonian fluid.

12. The embossing device according to claim 8, wherein
the embossing device is fastenable as a tool to a forming tool via the fastening device.

13. The embossing device according to claim 8, wherein
the embossing unit comprises at least two stamping wheels by which the marking is set and is embossed into the motor vehicle component, the two stamping wheels being cushioned together relative to the tool via the spring device.

14. A tool for processing a motor vehicle component, comprising:
an embossing device configured to emboss a marking on the motor vehicle component, the embossing device; comprising
a fastening device;
a spring device by which the fastening device is spring-mounted on the tool; and
an embossing unit, held on the fastening device, the embossing unit having the marking in negative, and by which the marking is embossed into the motor vehicle component by use of the tool when the motor vehicle component is processed.
